(19) United States
(12) Patent Application Publication
(10) Pub. No.: US 2011/0068641 A1
(43) Pub. Date: Mar. 24, 2011

(54) Horizontal linear vibrator

(75) Inventors: Jun Kun Choi, Suwon (KR); Hwa Young Oh, Seoul (KR); Yong Jin Kim, Suwon (KR)

(73) Assignee: SAMSUGN ELECTRO-MECHANICS CO.,LTD., Suwon (KR)

(21) Appl. No.: 12/923,039

(22) Filed: Aug. 30, 2010

(30) Foreign Application Priority Data
Sep. 24, 2009 (KR) 10-2009-0090626

(51) Int. Cl. H02K 33/00

(52) U.S. Cl. 310/25

(57) ABSTRACT

A horizontal linear vibrator includes: a bracket having a coil part with a hollow; a vibration unit including a yoke part having an accommodation space for accommodating the coil part therein and a passage hole formed to pass through the accommodation space; and a magnetic field unit including a magnet disposed in the accommodation space through the passage hole and providing an electromagnetic force to allow the vibration unit to horizontally move by an interaction of the coil part and the magnet.

### CROSS-REFERENCE TO RELATED APPLICATIONS

This application claims the priority of Korean Patent Application No. 10-2009-0090626 filed on Sep. 24, 2009, in the Korean Intellectual Property Office, the disclosure of which is incorporated herein by reference.

### BACKGROUND OF THE INVENTION

1. Field of the Invention

The present invention relates to a horizontal linear vibrator and, more particularly, to a horizontal linear vibrator designed to be mounted on a personal mobile terminal to vibrate.

2. Description of the Related Art

In general, one of the key functions requisite for communication devices is a call reception function. Commonly used call reception functions include a sound generating function that generates a melody or a bell sound and a vibration function that transfers vibrations to a device.

Among the functions, the vibration function is commonly used so as not to interfere with others by preventing a melody or a bell sound from being transferred to the exterior through a speaker.

In order to implement such a vibration function, in general, a small vibration motor is driven to transfer a driving force to a case of a device to make the device vibrate.

In particular, recently, as mobile terminals have been reduced in size and have improved in quality, the use of a touch screen type display device has been greatly favored, requiring a vibration generation function when a touch is applied to the touch screen, so the improvement of the vibration motor has gradually taken place.

A vibration motor applied to mobile phones generates rotatory power in order to rotate a rotational part of an unbalance mass, thus obtaining mechanical vibrations, and in this case, rotatory power is generated such that it is mostly subjected to a rectifying action through a brush and a contact point of a commutator (or rectifier) to provide current to a rotor coil.

However, in the brush type structure using a commutator, when the motor rotates, the brush passes through the gap between segments of the commutator, generating a mechanical friction and an electrical spark, abrading the brush and the commutator and thereby shortening the life span of the motor.

In addition, because voltage is applied to the motor by using a moment of inertia, time is taken to reach a target amount of vibrations, so it is difficult to implement vibrations suitable for touch screen-employed personal mobile terminals and the like.

### SUMMARY OF THE INVENTION

An aspect of the present invention provides a horizontal linear vibrator which vibrates horizontally in a lengthwise direction of a personal mobile terminal and can be simply assembled.

According to an aspect of the present invention, there is provided a horizontal linear vibrator including: a bracket having a coil part with a hollow; a vibration unit including a yoke part having an accommodation space for accommodating the coil part therein and a passage hole formed to pass through the accommodation space; and a magnetic field unit including a magnet disposed in the accommodation space through the passage hole and providing an electromagnetic force to allow the vibration unit to horizontally move by an interaction of the coil part and the magnet.

The passage hole may have a circular shape, and the magnet may have a cylindrical shape corresponding to the passage hole.

An insertion hole may be formed on an outer surface of the bracket such that it is positioned in a straight line with the passage hole.

The magnets may be formed at both sides of a magnetic core such that their polarities face each other.

The vibration unit may include the yoke part accommodating the magnetic field unit therein, and the yoke part may include an extending part extending to be bent so as to be tightly attached to outer surfaces of a mass body.

A bobbin may be formed at an upper portion of the bracket such that the coil part is inserted therein.

The coil part may have a quadrangular shape.

A circuit board may be installed on the upper portion of the bracket and connected with an external input terminal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view for explaining a horizontal linear vibrator according to an exemplary embodiment of the present invention;

FIG. 2 is an exploded perspective view of the horizontal linear vibrator of FIG. 1; and

FIGS. 3 to 5 are perspective views for explaining the process of assembling the horizontal linear vibrator and an effect of the horizontal linear vibrator according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions may be exaggerated for clarity, and the same reference numerals will be used throughout to designate the same or like components.

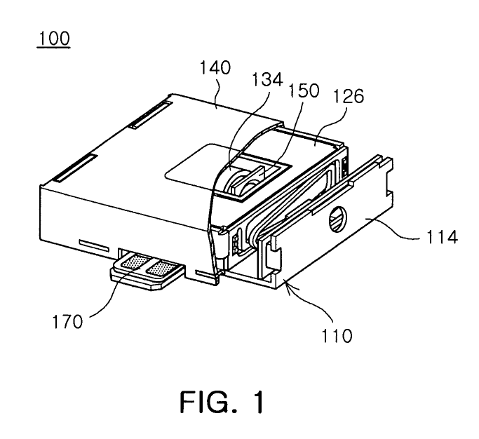

A horizontal linear vibrator according to exemplary embodiments of the present invention will now be described in detail with reference to FIGS. 1 to 5.

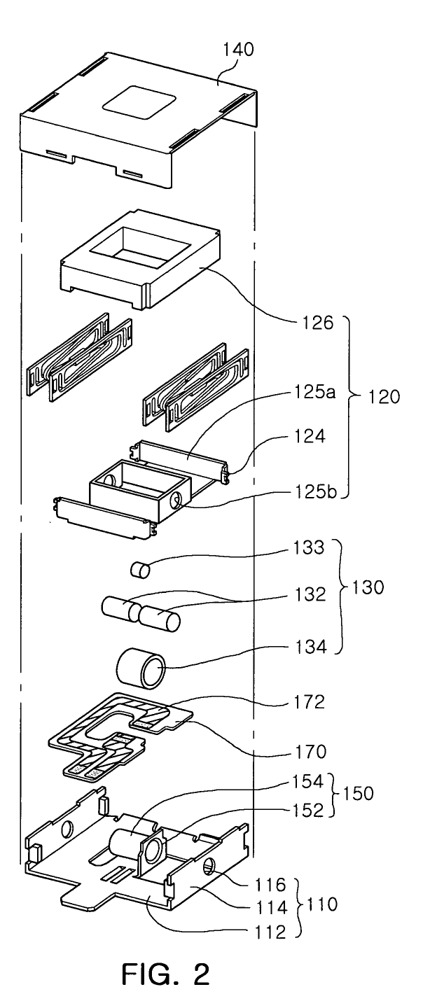

FIG. 1 is a perspective view for explaining a horizontal linear vibrator according to an exemplary embodiment of the present invention, and FIG. 2 is an exploded perspective view of the horizontal linear vibrator of FIG. 1.

With reference to FIGS. 1 and 2, a horizontal linear vibrator 100 may include a bracket 110, a vibration unit 120, a magnetic field unit 130, and a cover unit 140.

The bracket 110 has a structure in which an upper portion and a lengthwise directional side portion of the bracket 110 are open to correspond to the cover unit 140. Namely, the bracket 110 is formed to have a bracket lower plate 112 and widthwise directional side portions 114 and assembled with the cover unit 140 to form an internal space.

A bobbin 150 may be formed on an upper portion of the bracket lower plate 112 in order to insertedly fix a cylindrical coil 134, and a circuit board 170 may be mounted to be positioned near the bobbin 150.

The side portions 114 are formed to be bent to be perpendicular to the bracket lower plate 112 to allow spring members 180 to be insertedly fixed to an inner circumferential surface of the side portions 114. Thus, as the both sides of the bracket 110 are bent to be perpendicular to the bracket lower plate 112, having a channel-like shape, but the shape of the bracket 110 is not limited thereto.

An insertion hole 116 may be formed at a position of the side portion, of the bracket 110, corresponding to the passage hole 125b formed at the yoke part 124. In this case, the size of the insertion hole 116 may correspond to the size of the magnet 132, and accordingly, the magnet 132 can be assembled by passing through the insertion hole 116 and the passage hole 125b.

The bobbin 150 is positioned at the center of the upper portion of the bracket lower plate 112 and may include a vertical plate part 152 bent to be vertical to the bracket lower plate 112 and a cylindrical part 154 extending from the vertical plate part 152 such that it is horizontal to the bracket lower plate 112.

The vertical plate part 152 and the cylindrical part 154 may have a hollow portion through which a magnet 132 moves reciprocally.

Here, a cylindrical coil 134 is insertedly fixed on an outer circumferential surface of the bobbin 150, and the bobbin 150 has the cylindrical shape with a hollow portion therein allowing the magnet 132 to make a reciprocal movement therethrough. However, the structure of the bobbin 150 is not limited thereto, and the structure may be omitted.

The circuit board 170 is connected with an external input terminal and transfers power applied thereto to the cylindrical coil 134. The circuit board 170 may include a pattern part 172 formed on its upper surface and an opening part formed therein to allow the bobbin 150 to pass therethrough.

However, the circuit board 170 is not limited to the configuration in which it is formed separately from the bracket 110. Namely, the circuit board 170 and the bracket 110 may be integrally formed according to a designer's intention.

The coil part may include the cylindrical coil 134. The cylindrical coil 134 serves to generate an electric field of a certain strength when power is applied thereto from an external source. The cylindrical coil 134 may be inserted onto the outer circumferential surface of the cylindrical part 154 of the bobbin 150.

A coil line of the cylindrical coil 134 is connected with the pattern part 172 of the circuit board 170 through soldering, whereby power can be applied to the cylindrical coil 134 from an external source. However, the coil part is not limited to the cylindrical shape, and a rectangular coil may be applicable.

The vibration unit 120 includes the yoke part 124 accommodating both the cylindrical coil 134 and the magnet 132 therein, and a mass body 126 accommodating the magnet 132 and the yoke part 124. The vibration unit 120 moves in a horizontal vibration direction by an interaction of the magnet 132 and the cylindrical coil 134.

The magnetic field unit 130 includes the cylindrical coil 132 accommodated within the bobbin 150 and the magnet 132 disposed to be adjacent to the cylindrical coil 134.

A vibration direction of the vibration unit 120 is determined according to the Lorentz Force by an electric force of the frequency generated from the cylindrical coil 134 and the direction of a magnetic field generated toward the yoke part 124 from the magnet 132.

The magnet 132 serves to force the vibration unit to move linearly according to its interaction with the cylindrical coil 134 by generating a magnetic field of a certain strength. The magnets 132 are attached to both sides of a magnetic core 133.

Here, the magnets 132 attached to both sides of the magnetic core 133 may be disposed such that the same polarities face each other.

In this case, a magnetic fluid may be coated on an outer circumferential surface of the magnet 132 in order to prevent the magnet 132 from being directly brought into contact with an inner circumferential surface of the cylindrical part 154 of the bobbin 150 when the mass body 126 vibrates horizontally.

Here, the magnetic fluid is obtained by stably dispersing magnetic powder in a colloid shape in a liquid and then adding a surfactant thereto to prevent the magnetic powder from being precipitated or coagulated due to gravitation or a magnetic field. For example, the magnetic fluid may include a magnetic fluid obtained by dispersing triiron tetroxide or iron-cobalt alloy molecules in oil or water and, recently, a magnetic fluid obtained by dispersing cobalt in toluene.

The magnetic powder is ultrafine particles having a size of 0.01 μm to 0.02 μm, has Brownian motion peculiar to ultrafine particles, and has the characteristics that the concentration of the magnetic powder particles in the fluid is uniformly maintained even when an external magnetic field, gravitation, centrifugal force, or the like, is applied thereto.

The yoke part 124 serves to self-close a circuit to smoothly form a magnetic flux of the magnet 132. The yoke part 124 may have an internal space in which the cylindrical coil 134 and the magnet 132 are accommodated.

In order to have the internal space, side walls having a size enough to accommodate the magnet 132 and the bobbin 150. The passage hole 125b may be formed on the side wall to allow the magnet 132 to be inserted therethrough.

Both sides of the yoke part 124 may include extending parts 125 bent so as to be positioned perpendicular to the bracket lower plate 112 and tightly attached to the outer side of the mass body. Thus, when a central portion of the yoke part 124 is accommodated in the accommodation space of the mass body 126, the extending parts 125 can be tightly attached to the outer side of the mass body 126, and thus, the mass body 126 and the extending parts 126 can be stably bound.

The mass body 126 serves to apply a certain mass to the vibration unit 120 for linear vibrations, and includes an accommodation space to accommodate the central portion of the yoke part 124 therein. Thus, the mass body 126 accommodates the central portion of the yoke part 124 accommodating the magnet 132 in its accommodating space, and assembled such that the extending parts 125 bent from the yoke part 124 are in contact with the outer sides of the mass body 126.

The mass body 126 may have a mass of a certain size and vibrates horizontally in a vibration direction according to an interaction of the magnet 132 and the cylindrical coil 134. Here, the vibration direction refers to a direction parallel to the cylindrical coil 134.

The spring members 180 serve to elastically support the vibration unit 120 to move horizontally in a linear direction. In a state in which one side of the spring members 180 are fixed to the widthwise directional side portions 114, the other side of the spring member 180 is fixed to the vibration unit 120, thus elastically supporting the vibration unit 120.

Here, the spring members 180 are provided as pairs in corresponding positions at both sides of the vibration unit 120, and disposed at an upper portion of the bracket 110. The spring member 180 may be, for example, a coil spring, a leaf spring, or the like.

The cover unit 140 is formed to cover the upper portion of the bracket 110 and protects the internal constituents against an external impact.

In this manner, the horizontal linear vibrator according to the present exemplary embodiment is mounted in a personal mobile terminal such that it vibrates horizontally in a lengthwise direction, of the personal mobile terminal, rather than in a thicknesswise direction, so the thickness of the personal mobile terminal can be reduced. Also, because the movement displacement of the vibration unit 120 is formed to be lengthy along the lengthwise direction of the personal mobile terminal to secure the movement displacement, vibration performance can be further improved.

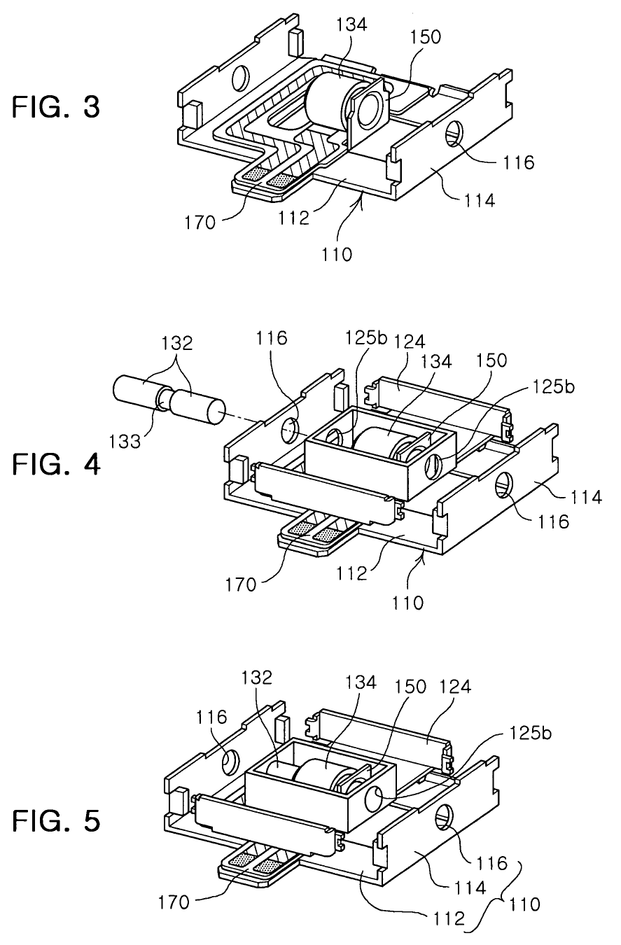

FIGS. 3 to 5 are perspective views for explaining the process of assembling the horizontal linear vibrator and an effect of the horizontal linear vibrator according to an exemplary embodiment of the present invention.

As shown in FIG. 3, the circuit board 170 is attached to the upper portion of the bracket 110. Here, the circuit board 170 is connected with an external input terminal to transfer power applied thereto to the cylindrical coil 134.

The cylindrical coil 134 may be disposed to surround the bobbin 150, and, according to this configuration, an empty space may be provided at the center of the bobbin 150 and the cylindrical coil 134, and the magnet 132 may be mounted in the empty space.

As shown in FIG. 4, the yoke part 124 is disposed to accommodate the cylindrical coil 134 on an inner surface of the bracket 110.

Here, the passage hole 125b may be formed on the side wall of the yoke part 124 accommodating the magnet 132 and the bobbin 150.

In this case, the insertion hole 116 may be formed at the position of the side portion, of the bracket 110, corresponding to the passage hole 125b formed at the yoke part 124. In this case, the passage hole 125b and the insertion hole 116 are positioned on the straight line.

Accordingly, as shown in FIGS. 4 and 5, the magnet 132 attached to both sides of the magnetic core 133 passes through the insertion hole 116 and the passage hole 125b so as to be disposed in the hollow of the cylindrical coil 134. The magnet 132 generates a magnetic field of a certain strength to allow the vibration to linearly move according to its interaction with the cylindrical coil 134.

As set forth above, according to exemplary embodiments of the invention, because the horizontal linear vibrator is mounted in a personal mobile terminal such that it vibrates in a horizontal direction, namely, in a lengthwise direction, rather than in a thicknesswise direction, of the personal mobile terminal, the personal mobile terminal can become slimmer. Also, because the movement displacement of the vibration unit is lengthy along the lengthwise direction of the personal mobile terminal to secure the movement displacement of the vibration unit, the vibration performance can be improved.

In addition, because the horizontal linear vibrator includes the yoke part having the passage hole passing through the accommodation space accommodating the coil part and the bracket having an insertion hole corresponding to the passage hole, after the bracket is assembled to the yoke part, a magnet can be easily inserted from the exterior, thus facilitating the assembling process.

While the present invention has been shown and described in connection with the exemplary embodiments, it will be apparent to those skilled in the art that modifications and variations can be made without departing from the spirit and scope of the invention as defined by the appended claims.

What is claimed is:

1. A horizontal linear vibrator comprising:
a bracket having a coil part with a hollow;
a vibration unit including a yoke part having an accommodation space for accommodating the coil part therein and a passage hole formed to pass through the accommodation space; and
a magnetic field unit including a magnet disposed in the accommodation space through the passage hole and providing an electromagnetic force to allow the vibration unit to horizontally move by an interaction of the coil part and the magnet.

2. The vibrator of claim 1, wherein the passage hole has a circular shape, and the magnet has a cylindrical shape corresponding to the passage hole.

3. The vibrator of claim 1, wherein an insertion hole is formed on an outer surface of the bracket such that it is positioned in a straight line with the passage hole.

4. The vibrator of claim 1, wherein the magnets are formed at both sides of a magnetic core such that their polarities face each other.

5. The vibrator of claim 1, wherein the vibration unit comprises the yoke part accommodating the magnetic field unit therein, and the yoke part comprises an extending part extending to be bent so as to be tightly attached to outer surfaces of a mass body.

6. The vibrator of claim 1, wherein a bobbin is formed at an upper portion of the bracket such that the coil part is inserted therein.

7. The vibrator of claim 1, wherein the coil part has a quadrangular shape.

8. The vibrator of claim 1, wherein a circuit board is installed on the upper portion of the bracket and connected with an external input terminal.
